(19) United States
(12) Patent Application Publication
(10) Pub. No.: US 2012/0092369 A1
(43) Pub. Date: Apr. 19, 2012

(54) DISPLAY APPARATUS AND DISPLAY METHOD FOR IMPROVING VISIBILITY OF AUGMENTED REALITY OBJECT

(75) Inventors: Ki Nam KIM, Goyang-si (KR); Bub Yeon KIM, Seoul (KR); Hea Beck YANG, Namyangju-si (KR); Seung Jae LEE, Seoul (KR)

(73) Assignee: PANTECH CO., LTD., Seoul (KR)

(21) Appl. No.: 13/012,249

(22) Filed: Jan. 24, 2011

(30) Foreign Application Priority Data
Oct. 19, 2010 (KR) 10-2010-0101805

(51) Int. Cl. G09G 5/00

(52) U.S. Cl. 345/633

(57) ABSTRACT

Provided are a display apparatus and a display method for improving visibility of each object by differently displaying each object from the background when providing an augmented reality (AR) service. The display apparatus and the display method may improve visibility of each object by outputting a list of overlapped objects or a map of overlapped objects. Also, the display apparatus and the display method may improve visibility of each object by enlarging a complex area, in which objects are densely disposed, to reduce overlapping of the objects.

### CROSS-REFERENCE TO RELATED APPLICATION

This application claims priority from and the benefit under 35 U.S.C. §119(a) of Korean Patent Application No. 10-2010-0101805, filed on Oct. 19, 2010, which is hereby incorporated by reference for all purposes as if fully set forth herein.

### BACKGROUND

1. Field

Exemplary embodiments of the present invention relate to a display apparatus and a display method for providing an augmented reality (AR).

2. Discussion of the Background

Augmented reality (AR) is a technology for overlaying a two-dimensional or three-dimensional virtual object on a view of the real environment, i.e., for combining a real world environment with a graphic-based virtual environment in real time, thereby enhancing understanding of reality. As an example, while a sports event is broadcast, a national flag of a nation of an entering player or information of the player may be displayed. As another example, a view of a real world environment that is augmented by computer graphics, characters, and the like, may be displayed on a head-mounted display (HMD) in real time.

In the case of AR, conventional methods for outputting various information of an object including a location of the object, the content of the object, and the like, on a display may include representing a specific location and basic information of an object on a two-dimensional map, outputting information on a three-dimensional display using location data, outputting information based on location data per distance, and the like.

However, if many objects are outputted during execution of an AR service, the objects may be overlapped, and consequently, visibility of the objects may be reduced. Also, during execution of an AR service, objects may not be easily recognized depending on either luminance (brightness of light) around a user, or color, brightness, and texture of the objects seen to the user.

### SUMMARY

Exemplary embodiments of the present invention provide a display apparatus and a display method for improving visibility of an augmented reality (AR) object.

Exemplary embodiments of the present invention also provide a display apparatus and a display method for improving visibility of each object by differently displaying each object from the background during execution of an AR service.

Exemplary embodiments of the present invention also provide a display apparatus and a display method for improving visibility of each object by outputting a list of overlapped objects during execution of an AR service.

Exemplary embodiments of the present invention also provide a display apparatus and a display method for improving visibility of each object by outputting a map of overlapped objects during execution of an AR service.

Exemplary embodiments of the present invention also provide a display apparatus and a display method for improving visibility of each object by enlarging a complex area during execution of an AR service to reduce overlapping of objects.

Exemplary embodiments of the present invention also provide a display apparatus and a display method for improving visibility of an augmented reality (AR) object may output of a list or a map or enlargement of a complex area to decrease overlapping of objects due to a high density of the objects if objects and information in an augmented reality are displayed. Exemplary embodiments of the present invention also provide a display apparatus and a display method in which tag information of objects is easily recognized despite luminance (brightness of light) around a user, or color, brightness and texture of the objects seen to the user, by correcting color of the objects depending on luminance and background, resulting in improvement in visibility of the objects.

Additional features of the invention will be set forth in the description which follows, and in part will be apparent from the description, or may be learned by practice of the invention.

An exemplary embodiment of the present invention discloses a display method for improving visibility of an AR object, the display method including setting, as a complex area, an area having a density of objects higher than a specific reference value or an area inputted by a user; checking objects included in the complex area; determining a location at which to output a list of the objects included in the complex area; and outputting the list at the determined location on a display.

An exemplary Another exemplary embodiment of the present invention discloses a display method for improving visibility of an AR object, the display method including setting, as a complex area, an area having a density of objects higher than a specific reference value or an area inputted by a user; checking objects included in the complex area; determining a location at which to output a map representing locations of the objects included in the complex area at the determined location; and outputting the map at the determined location on a display.

An exemplary embodiment of the present invention discloses a display method for improving visibility of an AR object, the display method including setting, as a complex area, an area having a density of objects higher than a predetermined reference value or an area inputted by a user, checking objects included in the complex area, and enlarging the complex area to a predetermined size or a size inputted by the user to reduce overlapping of the objects included in the complex area.

An exemplary embodiment of the present invention discloses a display method for improving visibility of an AR object, the display method including searching for objects located in a direction of a captured image; determining a location at which located objects are to be displayed on the captured image; improving visibility of the located objects by correcting the visibility of the located objects based on at least one of brightness, color, and texture of a background on which the located objects are outputted; and displaying the located objects with the improved visibility.

An exemplary embodiment of the present invention discloses a display apparatus to improve visibility of an AR object, the display apparatus including a complex area setting unit to set, as a complex area, an area having a density of objects higher than a predetermined reference value or an area inputted by a user, and to check objects included in the complex area; an output location determining unit to determine a location at which a list of the objects included in the complex area is outputted; and an additional data processing unit to output the list at the determined location.

An exemplary embodiment of the present invention discloses a display apparatus to improve visibility of an AR object, the display apparatus including a complex area setting unit to set, as a complex area, an area having a density of objects higher than a predetermined reference value or an area inputted by a user, and to check objects included in the complex area; an output location determining unit to determine a location at which a map representing locations of the objects included in the complex area is outputted; and an additional data processing unit to output the map at the determined location.

An exemplary embodiment of the present invention discloses a display apparatus to improve visibility of an AR object, the display apparatus including a complex area setting unit to set, as a complex area, an area having a density of objects higher than a predetermined reference value or an area inputted by a user, and to check objects included in the complex area, and a complex area enlarging unit to enlarge the complex area to a predetermined size or a size inputted by the user to reduce overlapping of the objects included in the complex area.

An exemplary embodiment of the present invention discloses a display apparatus to improve visibility of an AR object, the display apparatus including an object searching unit to search for objects located in a direction of captured image; an AR processing unit to determining a location at which the located objects are displayed on the captured image; and a visibility correcting unit to improve visibility of the located objects by correcting the visibility of the located objects based on at least one of brightness, color, and texture of a background on which the located objects are outputted, and to output the located objects with the improved visibility.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating a structure of a display apparatus for improving visibility of augmented reality (AR) object according to an exemplary embodiment of the present invention.

FIG. 2 is a flowchart illustrating a display method for improving visibility of an AR object in a display apparatus according to an exemplary embodiment of the present invention.

FIG. 3 is a flowchart illustrating a method for displaying a list to improve visibility of an AR object in a display apparatus according to an exemplary embodiment of the present invention.

FIG. 4 is a flowchart illustrating a method for displaying a map to improve visibility of an AR object in a display apparatus according to an exemplary embodiment of the present invention.

FIG. 5 is a flowchart illustrating a method for enlarging a complex area to improve visibility of an AR object in a display apparatus according to an exemplary embodiment of the present invention.

FIG. 6 is a view illustrating a display according to an exemplary embodiment of the present invention according to the method of FIG. 2.

FIG. 7 is a view of a display according to an exemplary embodiment of the present invention according to the method of FIG. 3.

FIG. 8 is a view of a display according to an exemplary embodiment of the present invention according to the method of FIG. 3.

FIG. 9 is a view of a display according to an exemplary embodiment of the present invention according to the method of FIG. 3.

FIG. 10 is a view of a display according to an exemplary embodiment of the present invention according to the method of FIG. 3.

FIG. 11 is a view illustrating a display according to an exemplary embodiment of the present invention according to the method of FIG. 4.

FIG. 12 is a view illustrating a display according to an exemplary embodiment of the present invention according to the method of FIG. 5.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

Exemplary embodiments of the present invention may provide a display apparatus and a display method for improving visibility of an object outputted through an augmented reality (AR).

An “object” as used in the following description may represent an AR object by an AR service. Here, the AR object may be outputted as at least one of an icon, a tag, and information of an object.

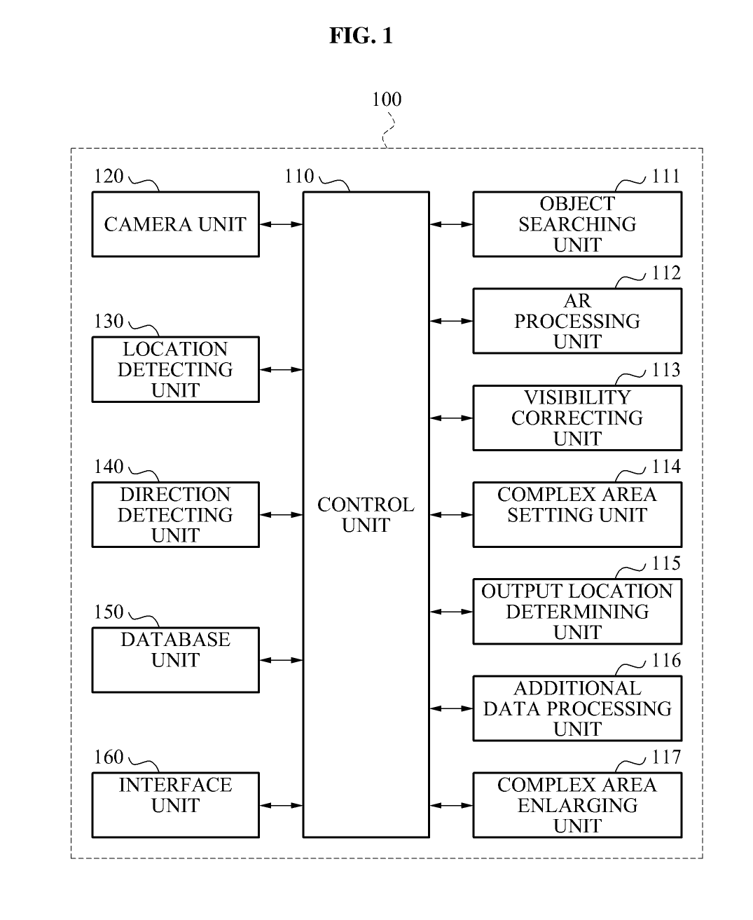

FIG. 1 is a block diagram illustrating a structure of a display apparatus for improving visibility of an augmented reality (AR) object according to an exemplary embodiment of the present invention.

Referring to FIG. 1, the display apparatus 100 may include a control unit 110, an object searching unit 111, an AR processing unit 112, a visibility correcting unit 113, a complex area setting unit 114, an output location determining unit 115, an additional data processing unit 116, a complex area enlarging unit 117, a camera unit 120, a location detecting unit 130, a direction detecting unit 140, a database unit 150, and an interface unit 160.

The camera unit 120 may be an imaging device or camera, and may provide an image or a preview image to the control unit 110. The image may be a still image or a moving image. The image may be corrected through image correction before the image is provided to the control unit 110. Also, the preview image may be corrected through camera correction before the preview image is provided to the control unit 110. Hereinafter, a term ‘image’ may include an image and a preview image.

The location detecting unit 130 may detect a location of the display apparatus 100. The location of the display apparatus 100 may be detected, for example, using a global positioning system (GPS) signal, using at least three neighboring base stations, using a distance with a nearby object of which a location is known, and the like.

The direction detecting unit 140 may detect a photographing direction of a camera or imaging device of the camera unit 120 of the display apparatus 100. An accelerator sensor, an accelerometer, or a Gyroscope may be used to detect a direction of the camera of the display apparatus 100.

The database unit 150 may store map data and information of an object mapped to a specific location on a map provided through an AR service.

The interface unit 160 may provide an interface to a user of the display apparatus 100, and may receive an input of the user.

The object searching unit 111 may search for objects located in a direction of an image being taken or captured, using a location of the display apparatus 100 detected by the location detecting unit 130 and a photographing direction of the display apparatus 100 detected by the direction detecting unit 140. Also, the object searching unit 111 may compute locations of the objects and distances between the display apparatus 100 and the objects.

If located objects are displayed on an image being taken, the AR processing unit 112 may determine a location at which the located objects are to be displayed on the image being taken.

The visibility correcting unit 113 may improve visibility of located objects by correcting the visibility of the located objects based on at least one of brightness, color, and texture of background on which the located objects are to be outputted, and may display the located objects having the improved visibility. Here, the visibility correcting unit 113 may improve visibility of the located objects by correcting the visibility of the located objects in at least one manner of generating an object background larger than each of the located objects by a specific size for to each of the located objects, of generating a shadow to each of the located objects, of changing color of each of the located objects to a complementary color to the background where each of the located objects is to be displayed, and of improving an output brightness of each of the located objects. Although the color change is described as being to a complementary color, aspects need not be limited thereto such that the color to which the located object is change need not be strictly complementary but may be different such that the visibility of the located object is improved with respect to the background on which the located object is to be displayed.

The complex area setting unit 114 may set a complex area, that is, an area having a high complexity, and may check objects included in the complex area. In this instance, the complex area setting unit 114 may set an area having a density of objects higher than a specific reference value as a complex area or may set an area inputted by a user as a complex area.

The output location determining unit 115 may determine a location to which additional data of objects included in a complex area is to be outputted. In this instance, the output location determining unit 115 may determine, as a location to which the additional data is to be outputted, a predetermined location, a location selected by a user, or an area at which an object does not exist on a display. Here, the additional data may be a list of objects included in a complex area, or a map indicating objects included in a complex area.

If additional data is a list, the additional data processing unit 116 may output a list of objects included in a complex area at a location to which the additional data is to be outputted as determined by the output location determining unit 115. In this instance, the additional data processing unit 116 may represent, in the list, the distances of the objects included in the complex area by a specific color set based on distance, or may represent, in the list, the distances of the objects included in the complex area by number.

Also, if the additional data processing unit 116 displays a list, the additional data processing unit 116 may arrange the objects included in the complex area in the list based on distance of the objects or names of the objects, and may display the list.

Also, if the number of objects included in the complex area exceeds a specific number, the additional data processing unit 116 may output a list of the predetermined number of objects among the objects included in the complex area, and may output a scroll bar which may change a portion of the list displayed by manipulation of the scroll bar.

Also, if an object included in the list is selected, the additional data processing unit 116 may differently display an object in the complex area corresponding to the object selected in the list from other objects. The differently displayed selected object may be more prominently displayed with respect to the non-selected objects, for example, by displaying the selected object as a color or transparency different from the non-selected objects. If an object corresponding to the object selected in the list is differently displayed compared to other objects by manipulation of a scroll bar, the additional data processing unit 116 may also differently display the selected object in the list from other objects in the list by manipulation of the scroll bar.

The additional data processing unit 116 may differently display an object corresponding to the object selected in the list from other objects in at least one manner of outputting an object corresponding to the object selected in the list at the front of the displayed objects, outputting an object corresponding to the object selected in the list larger than other objects, and outlining an object corresponding to the object selected in the list.

Also, the additional data processing unit 116 may improve visibility of names of the objects included in the list by correcting an output color of the objects included in the list based on at least one of brightness, color, and texture of background on which the list is to be outputted, to easily distinguish between the objects included in the list and the background.

When the additional data is a map, the additional data processing unit 116 may output a map representing locations of the objects included in the complex area at a location to which the additional data is to be outputted as determined by the output location determining unit 115.

When an enlargement event of a complex area occurs, the complex area enlarging unit 117 may enlarge the complex area to a predetermined size or a size inputted by the user to reduce overlapping of objects included in the complex area.

The control unit 110 may control the operation of the display apparatus 100. Also, the control unit 110 may include each of the object searching unit 111, the AR processing unit 112, the visibility correcting unit 113, the complex area setting unit 114, the output location determining unit 115, the additional data processing unit 116, and the complex area enlarging unit 117. The control unit 110, the object searching unit 111, the AR processing unit 112, the visibility correcting unit 113, the complex area setting unit 114, the output location determining unit 115, the additional data processing unit 116, and the complex area enlarging unit 117 are described separately for clarity of description; however, aspects of the present invention are not limited thereto. Accordingly, the control unit 110 may include at least one processor configured to perform functions of the object searching unit 111, the AR processing unit 112, the visibility correcting unit 113, the complex area setting unit 114, the output location determining unit 115, the additional data processing unit 116, and the complex area enlarging unit 117. Also, the control unit 110 may include at least one processor configured to perform a portion of functions of the object searching unit 111, the AR processing unit 112, the visibility correcting unit 113, the complex area setting unit 114, the output location determining unit 115, the additional data processing unit 116, and the complex area enlarging unit 117.

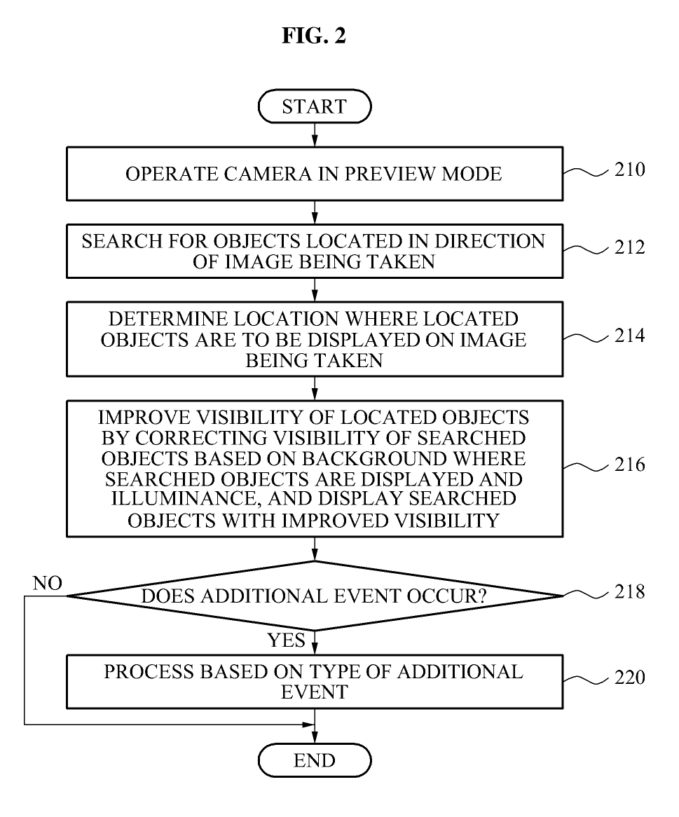

Hereinafter, a display method for improving visibility of an AR object according to the present invention is described with reference to FIG. 2.

FIG. 2 is a flowchart illustrating a display method for improving visibility of AR object in the display apparatus 100 according to an exemplary embodiment of the present invention. Referring to FIG. 2, in operation 210, the display apparatus 100 may operate a camera of the camera unit 120 in a preview mode during execution of an AR service.

In operation 212, the display apparatus 100 may search for objects located in a direction of an image being taken, i.e., a direction of the camera of the camera unit 120.

In operation 214, the display apparatus 100 may determine a location at which the located objects are to be displayed on the image being taken.

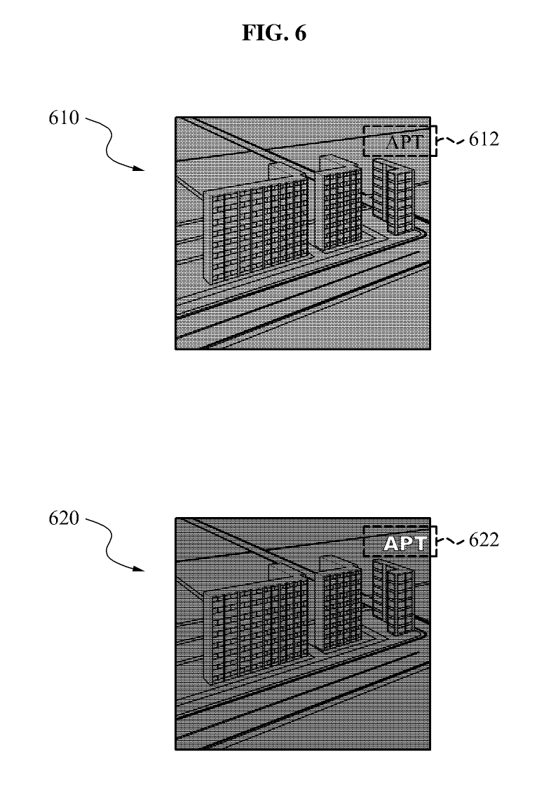

In operation 216, the display apparatus 100 may improve visibility of the located objects by correcting the visibility of the located objects based on at least one of brightness, color, and texture of background on which the located objects are to be outputted, and may display the located objects having the improved visibility. In this instance, correction for improving visibility of the located objects may include at least one correction by generating an object background larger than each of the located objects by a specific size for to each of the located objects, by generating a shadow for each of the located objects, by changing color of each of the located objects to a complementary color of background on which each of the located objects is to be displayed, and by improving an output brightness of each of the located objects. An example of correction is described below with reference to FIG. 6.

FIG. 6 is a view illustrating a display according to an exemplary embodiment of the present invention according to the method of FIG. 2. In FIG. 6, an AR display 610 before correction shows that a color of the background is similar to a color of a tag of an object 612 before correction and thus, visibility of the object 612 is not high. Conversely, an AR display 620 after correction shows that the color of an object 622 is changed to a complementary color to the background on which the object 622 is located and thus, visibility of the object 622 after correction is improved.

Referring back to FIG. 2, if the display apparatus 100 senses occurrence of an additional event requesting output of additional data in operation 218, the display apparatus 100 may output the additional data based on a type of the additional event, in operation 220.

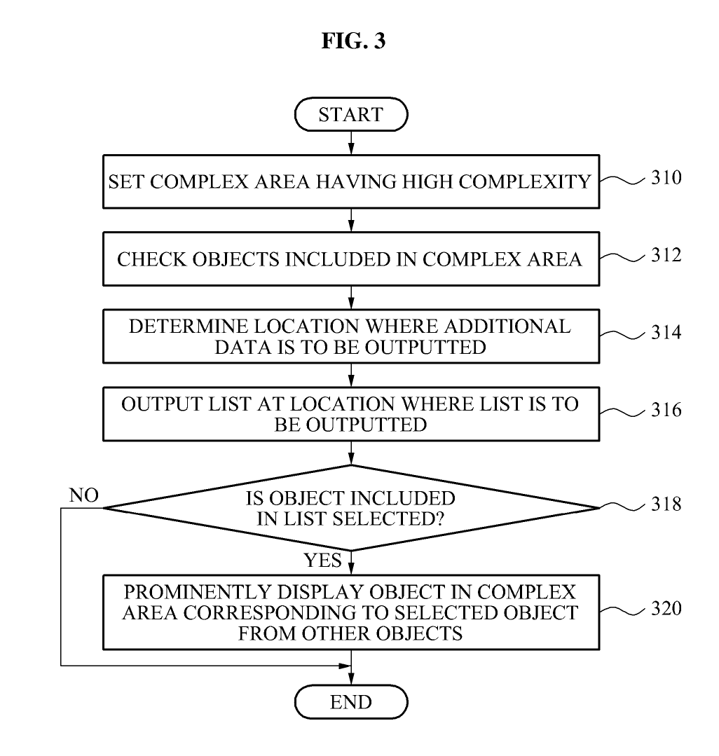

Examples of output of additional data based on a type of an additional event are described with reference to FIGS. 3 to 5.

FIG. 3 is a flowchart illustrating a method for displaying a list to improve visibility of an AR object in the display apparatus 100 according to an exemplary embodiment of the present invention. Referring to FIG. 3, in operation 310, the display apparatus 100 may set a complex area, that is, an area having a high complexity. In this instance, the display apparatus 100 may set an area having a density of objects higher than a predetermined reference value as a complex area, or may set an area inputted by a user as a complex area.

In operation 312, the display apparatus 100 may check objects included in the complex area. In operation 314, the display apparatus 100 may determine a location at which a list of objects included in the complex area, that is, a list corresponding to additional data, is to be outputted. In this instance, the display apparatus 100 may determine a predetermined location, a location selected by a user, or an area in which an object does not exist on a display, as a location where the list is to be outputted.

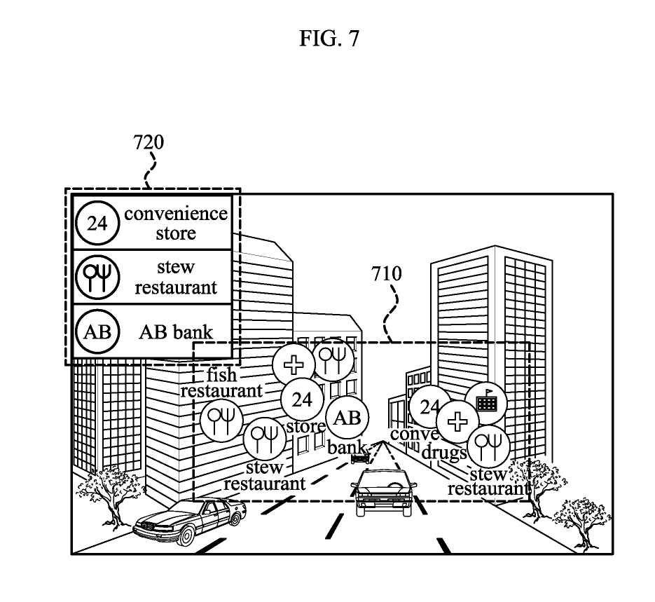

In operation 316, the display apparatus 100 may output the list at the determined location. The list may be displayed as shown in FIG. 7.

FIG. 7 is a view of a display according to an exemplary embodiment of the present invention according to the method of FIG. 3. Referring to FIG. 7, an area in which objects are overlapped may be set as a complex area 710, and a list of objects included in the complex area 710 may be displayed.

If the list is outputted in operation 316, the display apparatus 100 may arrange the objects included in the complex area in the list based on distances to the objects or names of the objects, and may output the list.

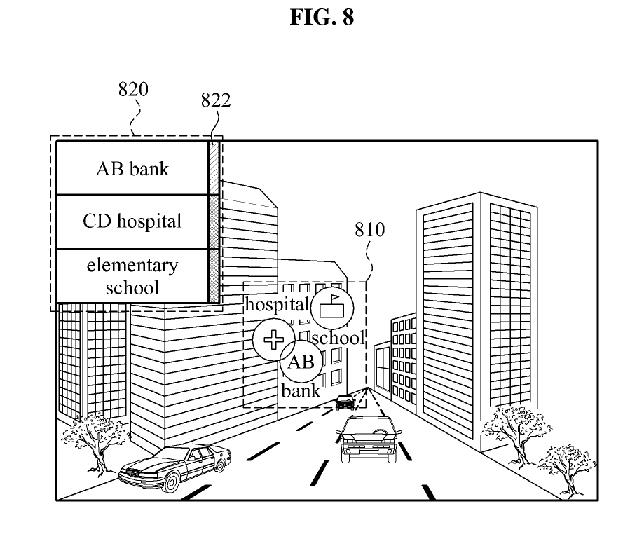

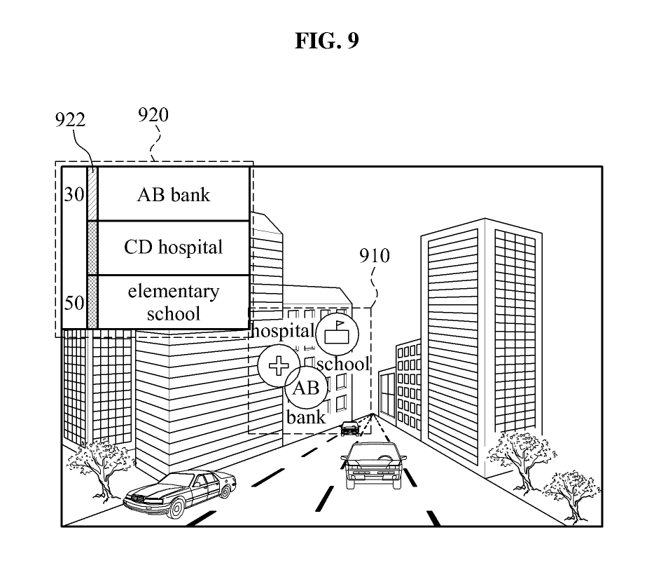

If the list is outputted in operation 316, the display apparatus 100 may represent the distances of the objects included in the complex area by a specific color set based on distance in the list, as shown in FIG. 8, or may represent the distances of the objects included in the complex area by number in the list, as shown in FIG. 9.

FIG. 8 is a view of a display according to an exemplary embodiment of the present invention according to the method of FIG. 3. In FIG. 8, distances of objects in a list are represented by colors. Referring to FIG. 8, an area in which objects are overlapped may be set as a complex area 810, and a list 820 of objects included in the complex area 810 may be displayed. A distance information bar 822 representing distance information of the objects included in the list 820 by color may be outputted next to each object in the list 820.

FIG. 9 is a view of a display according to an exemplary embodiment according to the method of FIG. 3. In FIG. 9, distances of objects in a list are represented by numbers. Referring to FIG. 9, an area in which objects are overlapped may be set as a complex area 910, and a list 920 of objects included in the complex area 910 may be displayed. A distance information bar 922 representing distance information of the objects included in the list 920 by number may be outputted next to the list 920. Further, the distance information bar 922 may additionally represent the distance information by color as shown in FIG. 9; however, aspects are not limited thereto such that the representation of the distance information by color need not be included in all aspects.

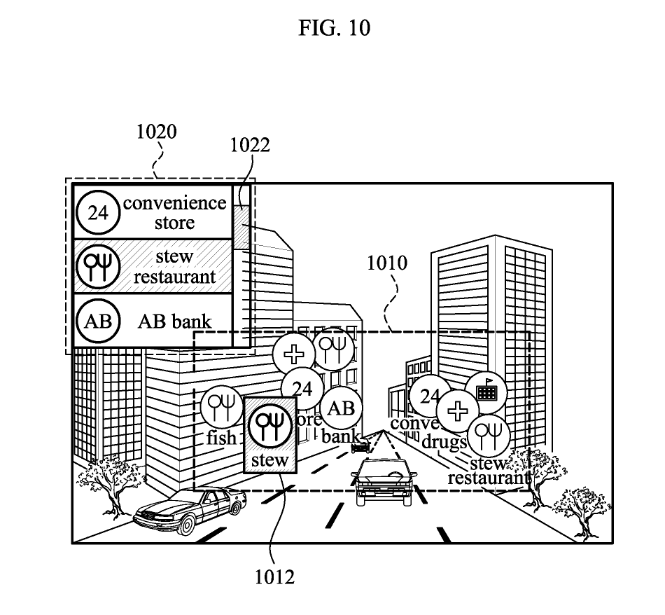

Referring back to FIG. 3, in operation 316 in which the list is outputted, if a number of objects included in the complex area exceeds a specific number, the display apparatus 100 may output a list of the specific number of objects among the objects included in the complex area, and may output a scroll bar which may change a portion of the list displayed by manipulation of the scroll bar and output the variable list, as shown in FIG. 10.

FIG. 10 is a view of a display according to an exemplary embodiment of the present invention according to the method of FIG. 3. In FIG. 10, a scroll bar is applied to a list and objects selected in the list are displayed. Referring to FIG. 10, an area in which objects are overlapped may be set as a complex area 1010, and a list 1020 of objects included in the complex area 1010 may be displayed. The list 1020 may be outputted as a combination of a portion of objects included in the complex area 1010 and a scroll bar 1022. The scroll bar 1022 allows for display of differing portions of the list of objects included in the complex area 1010.

Referring back to FIG. 3 again, in operation 318, the display apparatus 100 may check whether an object included in the list is selected. If an object included in the list is selected in operation 318, the display apparatus 100 may differently display an object in the complex area corresponding to the object selected in the list from other objects in operation 320.

For example, in FIG. 10, if an object ‘stew restaurant’ is selected in the list 1020, the display apparatus 100 may differently display an object 1012 ‘stew restaurant’ in a complex area 1010 corresponding to the selected object ‘stew restaurant’ from other objects.

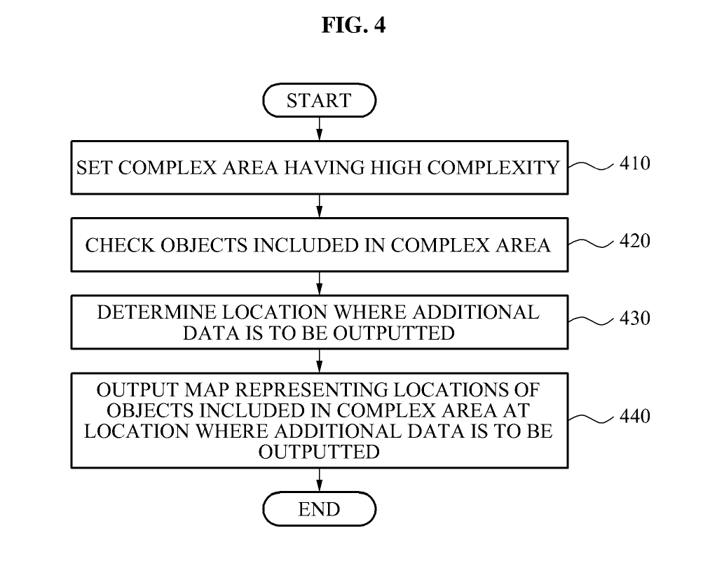

FIG. 4 is a flowchart illustrating a method for displaying a map to improve visibility of an AR object in the display apparatus 100 according to an exemplary embodiment of the present invention.

Referring to FIG. 4, in operation 410, the display apparatus 100 may set a complex area, that is, an area having a high complexity. In this instance, the display apparatus 100 may set an area having a density of objects higher than a specific reference value as a complex area, or may set an area inputted by a user as a complex area.

In operation 420, the display apparatus 100 may check objects included in the complex area.

In operation 430, the display apparatus 100 may determine a location at which a map representing locations of the objects included in the complex area, that is, a map corresponding to additional data, is to be outputted. In this instance, the display apparatus 100 may determine a predetermined location, a location selected by a user, or an area in which an object does not exist on a display, as a location where the map is to be outputted.

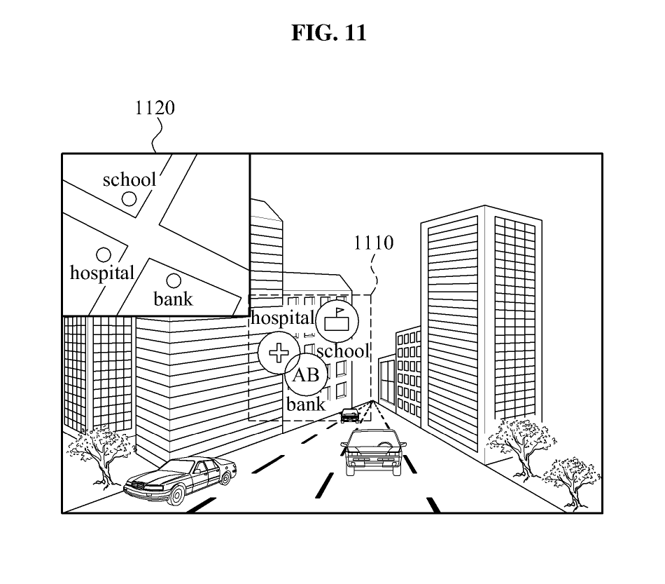

In operation 440, the display apparatus 100 may output the map representing locations of the objects included in the complex area at the location at which the additional data is determined to be outputted. The map may be displayed as shown in FIG. 11.

FIG. 11 is a view illustrating a display according to an exemplary embodiment of the present invention according to the method of FIG. 4. Referring to FIG. 11, an area in which objects are overlapped may be set as a complex area 1110, and a map 1120 indicating objects included in the complex area 1110 may be displayed. The map 1120 may be displayed as additional data in at a predetermined location, a location selected by a user, or an area in which an object does not exist on the display.

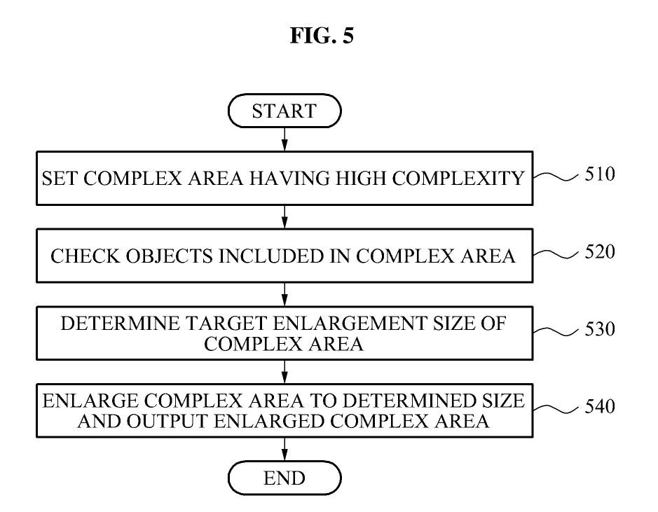

FIG. 5 is a flowchart illustrating a method for enlarging a complex area to improve visibility of an AR object in the display apparatus 100 according to an exemplary embodiment of the present invention.

Referring to FIG. 5, in operation 510, the display apparatus 100 may set a complex area, that is, an area having a high complexity. The display apparatus 100 may set an area having a density of objects larger than a predetermined reference value as a complex area, or may set an area inputted by a user as a complex area.

In operation 520, the display apparatus 100 may check objects included in the complex area.

In operation 530, the display apparatus 100 may determine a target enlargement size to which the complex area is to be enlarged. In this instance, the target enlargement size of the complex area may be a predetermined size or a size inputted by the user.

In operation 540, the display apparatus 100 may enlarge the complex area to the predetermined size or the size inputted by the user to reduce overlapping of the objects included in the complex area.

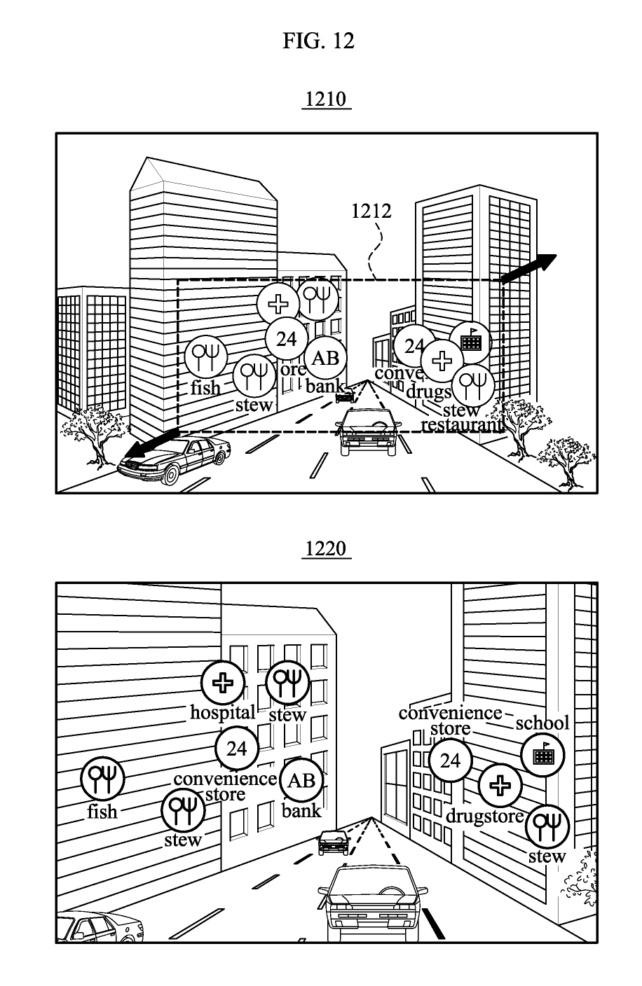

FIG. 12 is a view illustrating a display according to an exemplary embodiment of the present invention according to the method of FIG. 5. In FIG. 5, an AR display 1210 before enlargement shows that an area where objects are densely disposed and overlapped is set as a complex area 1212. An AR display 1220 after enlargement shows the complex area 1212 is enlarged to a greater display size and an overlapping degree of the objects is reduced.

The exemplary embodiments according to the present invention may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A display method for improving visibility of an augmented reality (AR) object, the display method comprising:
setting, as a complex area, an area having a density of objects higher than a specific reference value or an area inputted by a user;
checking objects included in the complex area;
determining a location at which to output a list of the objects included in the complex area; and
outputting the list at the determined location on a display.

2. The display method of claim 1, wherein the determining the location at which to output the list comprises determining, as the location, a predetermined location, a location selected by the user, or an area in which an object does not exist on the display.

3. The display method of claim 1, wherein the outputting the list comprises arranging the objects included in the complex area in the list based on distances to the objects or names of the objects.

4. The display method of claim 1, wherein the outputting the list comprises representing, in the list, the distances to the objects included in the complex area by a color set based on the distances, and/or representing, in the list, the distances to the objects included in the complex area by numbers.

5. The display method of claim 1, wherein the outputting the list comprises, if the number of objects included in the complex area exceeds a specific number, outputting the list including the specific number of objects among the objects included in the complex area, and outputting a scroll bar which changes a portion of the list displayed by manipulation of the scroll bar.

6. The display method of claim 1, further comprising:
if an object included in the list is selected, differently displaying an object in the complex area corresponding to the object selected in the list from other objects.

7. The display method of claim 6, wherein the differently displaying the object corresponding to the object selected in the list from other objects comprises at least one of outputting an object corresponding to the object selected in the list at the front of the displayed objects, outputting an object corresponding to the object selected in the list larger than other objects, and outlining an object corresponding to the object selected in the list.

8. The display method of claim 1, wherein the outputting the list comprises improving visibility of names of the objects included in the list by correcting an output color of the objects included in the list based on at least one of brightness, color, and texture of a background on which the list is outputted.

9. A display method for improving visibility of an augmented reality (AR) object, the display method comprising:
setting, as a complex area, an area having a density of objects higher than a specific reference value or an area inputted by a user;
checking objects included in the complex area;
determining a location at which to output a map representing locations of the objects included in the complex area at the determined location; and
outputting the map at the determined location on a display.

10. A display method for improving visibility of an augmented reality (AR) object, the display method comprising:
setting, as a complex area, an area having a density of objects higher than a predetermined reference value or an area inputted by a user;
checking objects included in the complex area; and
enlarging the complex area to a predetermined size or a size inputted by the user to reduce overlapping of the objects included in the complex area.

11. A display method for improving visibility of an augmented reality (AR) object, the display method comprising:
searching for objects located in a direction of a captured image;
determining a location at which located objects are to be displayed on the captured image;
improving visibility of the located objects by correcting the visibility of the located objects based on at least one of brightness, color, and texture of a background on which the located objects are outputted; and
displaying the located objects with the improved visibility.

12. The display method of claim 11, wherein the improving the visibility of the located objects comprises at least one correction by generating an object background larger than each of the located objects by a predetermined size for each of the located objects, by generating a shadow for each of the located objects, by changing a color of each of the located objects to a color different from the background on which each of the located objects is displayed, and by improving an output brightness of each of the located objects.

13. A display apparatus to improve visibility of an augmented reality (AR) object, the display apparatus comprising:
a complex area setting unit to set, as a complex area, an area having a density of objects higher than a predetermined reference value or an area inputted by a user, and to check objects included in the complex area;
an output location determining unit to determine a location at which a list of the objects included in the complex area is outputted; and
an additional data processing unit to output the list at the determined location.

14. The display apparatus of claim 13, wherein the additional data processing unit represents, in the list, the distances of the objects included in the complex area by a specific color set based on distance to the objects, or represents, in the list, the distances of the objects included in the complex area by numbers.

15. The display apparatus of claim 13, wherein, if an object included in the list is selected, the additional data processing unit differently displays an object in the complex area corresponding to the object selected included in the list from other objects, and
wherein the differently displayed object corresponding to the object selected in the list from the other objects comprises at least one of outputting an object corresponding to the object selected in the list at the front of the displayed objects, outputting an object corresponding to the object selected in the list larger than the other objects, and outlining an object corresponding to the object selected in the list.

16. The display apparatus of claim 13, wherein the additional data processing unit improves visibility of names of the objects included in the list by correcting an output color of the objects included in the list based on at least one of brightness, color, and texture of a background on which the list is outputted.

17. A display apparatus to improve visibility of an augmented reality (AR) object, the display apparatus comprising:
a complex area setting unit to set, as a complex area, an area having a density of objects higher than a predetermined reference value or an area inputted by a user, and to check objects included in the complex area;
an output location determining unit to determine a location at which a map representing locations of the objects included in the complex area is outputted; and
an additional data processing unit to output the map at the determined location.

18. A display apparatus to improve visibility of an augmented reality (AR) object, the display apparatus comprising:
a complex area setting unit to set, as a complex area, an area having a density of objects higher than a predetermined reference value or an area inputted by a user, and to check objects included in the complex area; and
a complex area enlarging unit to enlarge the complex area to a predetermined size or a size inputted by the user to reduce overlapping of the objects included in the complex area.

19. A display apparatus to improve visibility of an augmented reality (AR) object, the display apparatus comprising:
an object searching unit to search for objects located in a direction of captured image;
an AR processing unit to determining a location at which the located objects are displayed on the captured image; and
a visibility correcting unit to improve visibility of the located objects by correcting the visibility of the located objects based on at least one of brightness, color, and texture of a background on which the located objects are outputted, and to output the located objects with the improved visibility.

20. The display apparatus of claim 19, wherein the visibility correcting unit improves visibility of the located objects by correcting the visibility of the located objects in at least one manner of generating an object background larger than each of the located objects by a predetermined size for each of the located objects, of generating a shadow for each of the located objects, of changing a color of each of the located objects to a different color from the background on which each of the located objects is displayed, and of improving an output brightness of each of the located objects.
